(19) United States
(12) Patent Application Publication
(10) Pub. No.: US 2013/0240345 A1
(43) Pub. Date: Sep. 19, 2013

(54) MICROWAVE-BASED METHOD AND DEVICE FOR PRODUCING HIGH-PURITY LIQUIDS

(71) Applicant: Werner LAUTENSCHLAEGER, Widnau (CH)

(72) Inventor: Werner LAUTENSCHLAEGER, Widnau (CH)

(21) Appl. No.: 13/886,156

(22) Filed: May 2, 2013

Related U.S. Application Data
(63) Continuation of application No. PCT/EP2011/068158, filed on Oct. 18, 2011.

(30) Foreign Application Priority Data
Nov. 5, 2010 (DE) DE102010043494.9

(51) Int. Cl. B01D 3/32

(52) U.S. Cl. CPC B01D 3/32
USPC 203/2; 203/1; 202/185.1; 202/181; 202/185.3; 202/185.2

(57) ABSTRACT

A process for producing high-purity liquids, in particular liquid chemicals, by distillation, includes the steps of: providing a liquid to be purified from a storage vessel in a sample container arranged in a sample chamber, heating and evaporating the uppermost layers of the liquid to be purified, condensing the sample vapor produced of the liquid to be purified in a condensation device outside the sample chamber, and collecting the distillate in a collecting container. The collecting container being connectable to the storage vessel via a return line for the non-condensed sample vapor and forming a space that is closed off from the surroundings between the space above the liquid surface of the liquid to be purified in the sample chamber and the storage vessel.

This nonprovisional application is a continuation of International Application No. PCT/EP2011/068158, which was filed on Oct. 18, 2011, and which claims priority to German Patent Application No. DE 10 2010 043 494.9, which was filed in Germany on Nov. 5, 2010, and which are both herein incorporated by reference.

### BACKGROUND OF THE INVENTION

1. Field of the Invention

The invention relates to the production of high-purity liquids, in particular liquid chemicals, by distillation using microwave radiation.

2. Description of the Background Art

Chemicals usually contain a certain amount of impurities. To separate the liquid chemical from the impurities, it is usually distilled. Distillation comprises evaporating the liquid and condensing the vapors to produce the distillate, which is collected together (simple distillation) or in a separate manner according to boiling ranges (fractional distillation). Since simple distillation does not achieve complete mixture separation, it is only used when high purity is unimportant. Fractional distillation is used, for example, in the treatment of petroleum or the production of alcohol.

Since, according to Raoult's Law, the higher-boiling substance also sends a quantity corresponding to its content and vapor pressure into the vapor of the lower-boiling substance, accurate separation is only possible by means of a multiplicity of successive distillation steps. Rectification, in which a so-called distillation column is connected between the evaporator and the cooler, is a process for the very fine separation of liquid mixtures.

DE 196 39 022 A1, which corresponds to U.S. Pat. No. 6,303,005, discloses a process for producing high-purity liquids by distillation in which the liquid to be purified is heated by microwave irradiation with preference in the uppermost layer. For this purpose, the level of the liquid surface is kept constant during the process by means of a leveling system. The uppermost layer of the liquid to be purified consequently evaporates, and the upwardly escaping vapor passes through vapor through-holes in a guiding tube of a condensation device arranged above the liquid surface and condenses on a cooling finger which is arranged therein and cooled. The condensate drips down on the inside of the guiding tube and flows along the inclined guiding tube into a collecting container. Since the condenser cannot have an efficiency of 100%, on the upper side of the collecting container there is consequently distillate vapor, which may be able to escape into the surroundings. Moreover, the system is of an open design, at least with respect to the gas flow, so that both the vapor from the sample and the distillate may still be contaminated after being collected in the collecting container. This has to be avoided, however, in the production of high-purity liquids, particular high-purity liquid chemicals.

### SUMMARY OF THE INVENTION

It is therefore an object of the invention to provide a distillation process for producing high-purity liquid chemicals and a device for carrying out this process with which an improved purity of the distillate can be achieved.

According to an embodiment of the invention, a process for producing high-purity liquids, in particular liquid chemicals, by distillation is made available, including the following steps: providing a liquid to be purified from a storage vessel in a sample container arranged in a sample chamber, heating and evaporating the uppermost layers of the liquid to be purified, condensing the sample vapor produced of the liquid to be purified in a condensation device outside the sample chamber, and collecting the distillate in a collecting container, the collecting container being connected to the storage vessel via a return line for the non-condensed sample vapor and forming a space that is closed off from the surroundings between the space above the liquid surface of the liquid to be purified in the sample chamber and the storage vessel.

In this way, a clean-room atmosphere can be provided in the system, to be more precise in the region of the system in which the distillate, including the non-condensed distillate, moves, so that a particularly high-purity distillate can be produced. Contaminants from the outside world are consequently virtually excluded after the distillation in the system. Moreover, no distillate is lost either, since non-condensed distillate is returned to the system via the storage vessel.

It is also provided that the liquid to be purified can be heated by microwave irradiation with preference in the uppermost layers, while lower layers remain cooler. This measure may prevent higher-boiling impurities from being entrained into the vapor by bubble formation. In the corresponding device, the heat source in the form of a microwave radiation source is arranged above the liquid to be purified.

Furthermore, convection within the liquid is largely prevented by introducing horizontal nets or perforated orifice plates into the liquid. This measure may likewise reduce the effect by which impurities are entrained from the bottom upward by the heat transfer within the liquid and find their way into the distillate. These orifice plates may, for example, also be filled with graphite, in order in this way to heat the liquid indirectly by the microwave irradiation.

Furthermore, the liquid level in the sample container is kept substantially constant during the distillation process, in that the sample container is fed from a leveling system. For this purpose, the sample container can be connected to a storage vessel, from which a pump pumps the chemical to be purified into an overflow stub, which is connected in the upper part to the storage vessel and the lower end of which opens via an inflow into a lower region of the sample container.

For this purpose, the inflow can be formed as a siphon and, particularly preferably, has at its lower knee an outflow device, preferably a draining valve, in order to selectively drain off impurities in the liquid to be purified.

Moreover, the temperature distribution in the liquid can be monitored by at least two temperature measuring devices, of which at least one temperature measuring device measures the temperature in the uppermost layer of the liquid and at least one temperature measuring device measures the temperature in the lower region of the liquid, to control the output of the radiation that is incident on the liquid surface and the feed of cold liquid to be purified into the sample container.

Furthermore, a negative pressure or a vacuum may be generated in the storage vessel or in the return line by a device, the generated negative pressure also prevailing on the liquid surface of the liquid to be purified in the sample chamber by way of the connection to the return line. In this way, the evaporation and the draining off of the sample vapor from the space above the surface of the liquid to be purified can be promoted. The device generating the negative pressure preferably comprises a fan, which by pumping out gas in the storage vessel or in the return line preferably generates a vacuum therein. Furthermore, the inlet side of the device generating the negative pressure is preferably provided with a filter.

Moreover, as a safety feature, the pressure in an outlet stub or distillation line connecting the sample chamber and the condensation device may be measured by way of a pressure sensor, the microwave output being reduced or switched off if a limit pressure is exceeded. For this purpose, the pressure sensor is connected to a control unit, which is provided for controlling the output of the radiation that is incident on the liquid surface.

A cover may divide the sample chamber into an upper sample chamber, into which the microwaves are coupled, and a lower sample chamber, in which the sample container is received, the cover being of a form that is transparent to microwaves. It is in this way possible to make the one upper sample chamber available; for example opening doors or the like may be provided therein in a simple way. Particularly preferably, the cover lifts off from the sample container if a predetermined vapor pressure in the sample container is exceeded.

The condensation device can be formed as a water cooler, a circulating cryostat or an air cooler. If it is formed as an air cooler, the fan that is used for generating the negative pressure in the system may at the same time be intended for providing the air stream intended for cooling. This obviates the need for some components, and the entire system, including the condensation device, is formed such that it is closed off from the outside world.

All of the elements that come into contact with the chemical in the course of the distillation process must be resistant to the chemical used. Glass may be used as a material in the case of chemicals that are not excessively aggressive; if, for example, the chemical to be purified is hydrofluoric acid, which attacks glass, polytetrafluoroethylene (PTFE) may be used for example.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus, is not limitive of the present invention, and wherein the sole FIGURE illustrates an example embodiment, showing a cross-sectional view of an adjustment fitting with sealing of the eccentric receiving space, and wherein the sole FIGURE shows a basic representation of an exemplary embodiment of the device according to an embodiment of the invention.

### DETAILED DESCRIPTION

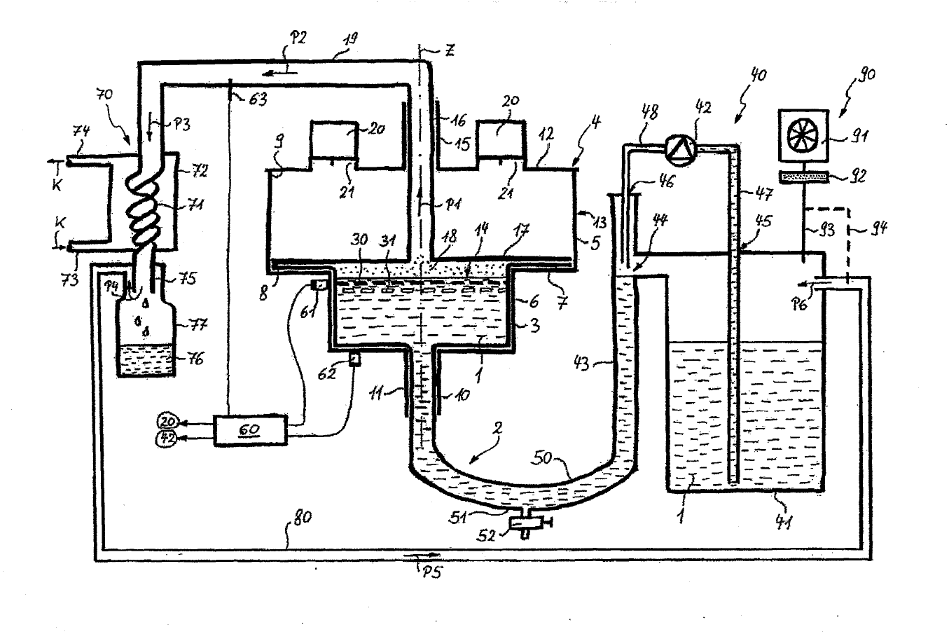

On the basis of FIG. 1, the process according to the invention and an exemplary embodiment of a device according to the invention are explained in principle below. The liquid chemical 1 to be purified is fed via an inflow 2 to a sample container 3, in the lower region thereof, and is intended to then be distilled with high purity. The sample container 3 preferably includes a microwave-transparent material. The sample container 3 is arranged in a sample chamber 4, preferably is inserted into it. Alternatively, the sample container 3 may also be formed by a corresponding coating of the inner side of the sample chamber 4.

Seen in the vertical direction, the sample chamber 4 is preferably formed in two stages, an upper sample chamber 5 and a lower sample chamber 6, and the sample container 3 is arranged or received in the lower sample chamber 6. The upper sample chamber 5 preferably has a greater diameter than the lower sample chamber 6, so that the two sample chambers 5, 6 are connected to one another by way of a step 7, on which the sample container 3 rests with a collar 8 extending horizontally outward at its upper end. In order to insert the preferably releasably arranged sample container 3 into the sample chamber 4, the upper sample chamber 5 preferably has an upper opening 9.

The sample container 3 inserted in the sample chamber 4, to be more specific the lower sample chamber 6, also has a downwardly protruding inlet stub 10, which preferably lies against a first stub 11 likewise extending downward partially with the inlet stub 10 from the lower sample chamber 6. The inlet stub extends further into, or is formed integrally with, the inflow 2, via which the liquid chemical 1 to be purified is fed to the sample container 3.

The sample chamber 4 also has a cover 12, closing the upper opening 9 of the upper sample chamber 5. This cover is either screwed on or fastened to the upper sample chamber 5, preferably releasably, by hinges or in some other known way.

The lower sample chamber 6 preferably has a round cross section, in order thereby to receive in it the preferably likewise round sample container 3. The sample container 3 in this case preferably lies directly against the Faraday's cage that is formed by the sample chamber 4 and the cover 12; in the present case therefore against the step 7, the lower sample chamber 6 and the stub 11.

The upper sample chamber 5 preferably has an angular cross section. In this way, a cover 12, provided by means of hinges, or opening doors or viewing windows can be easily provided on the sides 13. Alternatively, the upper sample chamber 5 may likewise be of a round form, the cover 12 then preferably being screwed onto the upper sample chamber 5. The two sample chambers 5, 6 may therefore have different geometrical forms, in particular with respect to their cross section in a plan view.

The microwave radiation is generated by a microwave generator (magnetron) 20 and is preferably coupled in in the upper region of the microwave sample chamber 4 by way of one or more coupling-in openings 21. The magnetrons 20 are preferably arranged on the upper side of the sample chamber 4, that is to say preferably on the cover 12. To generate the microwave radiation and to transfer the same from the microwave generator 20 to the coupling-in openings 21, generally conventional elements may be used. Alternatively, the microwaves may also be coupled in laterally via the side wall 13 of the upper sample chamber 5, the magnetrons 20 for this purpose preferably being provided on the side wall 13 of the upper sample chamber 5.

Instead of microwave radiation, infrared radiation may similarly be used for heating the chemical 1. However, the use of microwave beams has the advantage over infrared that they also allow indirect heating of the liquid 1, if a microwave-absorbing material 30 is introduced in the region of the uppermost layers of the liquid 1 just below the surface 14, as will be explained in more detail further below.

In the same way as also the lower sample chamber 6, the cover 12 has a second stub 15, extending outward away from it (that is to say upward). This stub is preferably in line with the first stub 11 in the lower sample chamber 6, the stubs 11, 15 also preferably extending along a central axis Z of the sample chamber 4.

An outlet stub 16 extends from the interior of the sample chamber 4 through the second stub 15 in the cover 12 out of the sample chamber 4 or the upper sample chamber 6. The outlet stub 16 thereby preferably extends into the sample chamber 4 as far as a horizontal plane which, seen in the vertical direction, corresponds to the height of the step 7. Since the inlet stub 10 and the outlet stub 16 consequently preferably extend in line along the central axis Z of the sample chamber 4, they form a passage along this axis Z. In addition, known measures have been taken, for example to prevent microwave radiation from escaping through these pipe stubs 10, 16 by reflection.

Outside the in-line pipe stubs (inlet stub 10 and outlet stub 16), the upper and lower sample chambers 5, 6 are separated by a chemically resistant and microwave-permeable cover 17, which preferably extends laterally from the end of the outlet stub 16 extending into the sample chamber 4. For this purpose, the outlet stub 16 and the cover 17 are preferably integrally formed. The cover 17 preferably rests on the step 7 or on the collar 8 of the sample container 3 resting on the step 7. The sample chamber 4 is consequently separated by the cover 17 into the upper sample chamber 5 and the lower sample chamber 6. Furthermore, the cover 17 closes off the sample container 3 upwardly from the surroundings.

At least the cover 17, but preferably also the outlet stub 16 and the entire sample container 3, are produced for example from PTFE material.

The entire sample chamber 4 (including cover 12) consequently serves as a Faraday's cage, which is provided jointly for the microwaves and the sample material 1. For this purpose, the sample chamber 4 and the cover 12 are preferably produced from a high-alloy steel or other known materials. Consequently, the microwaves remain within the sample chamber 4. The lower sample chamber 6 is closed off fluidically from the outside with respect to the surroundings within this Faraday's cage by the sample container 3 and its cover 17. On account of the microwave transparency of the cover 17, however, the microwaves that are coupled into the sample chamber 4 from the magnetrons 20 penetrate into the lower sample chamber 6, which receives the sample 1.

Unlike as shown in the exemplary embodiment of FIG. 1, and unlike as described above, the sample chamber 4 is not necessarily designed as two parts comprising an upper and lower sample chamber. Rather, the cover 12 of the sample chamber 4 could also be mounted directly on the lower sample chamber 6, for example by screw connections. For this purpose, the cover 12 preferably rests on the step 7 and, particularly preferably, encloses between itself and the step 7 the collar 8 of the sample container 3 and also the regions of the cover 17 of the lower sample chamber 6 that extend over the step 7. In this case, the height of the upper sample chamber 5 tends toward zero; the upper sample chamber 5 is consequently in fact scarcely present, if at all, so that this can be referred to as a one-part configuration. The lower sample chamber 6 in this case corresponds to the sample chamber 4.

The two-part configuration of the sample chamber 4 according to the representation in FIG. 1 has in particular the advantage over the one-part configuration that lateral doors (not represented) can preferably be fitted in the upper sample chamber 5. Consequently, the screws of the cover 12 do not have to be loosened and fastened again each time to exchange the sample container 3 or for repair purposes. Moreover, microwave-shielding viewing windows may also be incorporated in the side walls of the upper sample chamber 5.

As already stated, the liquid chemical 1 to be purified is fed via the inflow 2 and the inlet stub 10 into the sample container 3, in the lower region thereof. The feeding in this case preferably takes place by way of a level control, in order to keep the level of the liquid surface 14 constant in the sample chamber 4, to be more precise the lower sample chamber 6, to be even more precise the sample container 3, during the distillation process. For this purpose, the sample container 3 is fed via the inflow 2 from a leveling system 40.

The leveling system 40 is represented on the right-hand side of FIG. 1. The liquid chemical 1 to be purified is located in a storage vessel 41. From there, it is pumped by means of a pump 42 into an overflow stub 43, which is connected in the upper part to the storage vessel 41 and the lower end of which opens via the inflow 2 and the inlet stub 10 into the lower region of the sample container 3. In a region between the inlet stub 10 and the overflow stub 43, the inflow 2 is preferably formed as a siphon 50, in which the chemical 1 to be distilled is located. By the leveling system 40 thus formed, the level of the liquid surface 14 in the sample chamber 4, to be more precise the sample container 3, that is to say the lower sample chamber 6, is kept constant at the level of the upper end of the overflow stub 43 that is defined by the overflow 44, in particular even during the distillation. Unlike as represented in FIG. 1, the pump 42 may also be arranged within the storage vessel 41, in order in this way to obviate the need for additional sealing or closing of the outlet 45 and the inlet 46 for the pipe connections 47, 48 to and from the pump 42.

An outflow device, preferably in the form of a draining valve 52, is preferably provided at the lower knee 51 of the siphon 50, that is to say at the lowermost end thereof. The reason for this is that the residual materials of the cold liquid (not heated by microwaves) in the siphon 50 are enriched by the ongoing distillation. These salts and other impurities can then be selectively drained off by this draining valve 52. The outflow device 52 consequently allows draining off of the liquid chemical 1 to be purified to take place even during the distillation process, so that an excessively high concentration of impurities in the sample container 3 can be avoided. The drained-off sample with the impurities is discharged into a container that is not represented. In order to speed up the draining off, a pump device or the like may be provided between the draining valve 52 and the container.

The level of the liquid surface 14 in the sample chamber 4, to be more precise in the sample container 3, is therefore kept constant. Since the microwave irradiation preferably takes place from above, and since the liquid chemical 1 to be purified preferably absorbs the microwave radiation, the uppermost layers of the liquid 1 are intensely heated while the lower region remains cooler.

At least two temperature measuring devices 61 and 62, which are preferably formed as infrared thermal sensors, may be used for measuring the temperature distribution of the liquid 1 in the sample container 3. A first IR thermal sensor 61 measures the temperature in the hotter, upper liquid layers and a second IR thermal sensor 62 measures the temperature in the lower, cooler region of the liquid 1. The thermal sensors 61, 62 are connected to a control unit 60, which for its part is connected to the pump 42 of the leveling system 40 and to the radiation source 20.

Corresponding to the measurement result of the temperature distribution, on the one hand the feeding of cold liquid 1 to be purified into the sample container 3 and on the other hand the output of the radiation that is incident on the surface 14 of the liquid 1 are controlled. By keeping the temperature constant in the upper layers of the liquid 1 and also in the lower region, it is possible largely to prevent intermixing.

Irradiating the uppermost layer of the liquid 1 to be purified with microwaves has the disadvantage that, in particular as sample material 1 undergoes further heating, the microwaves penetrate ever deeper into the volume of the sample in the sample container 3. The aim is consequently to concentrate the microwave action (absorption) as far as possible in the surface layer, so that the microwave acting from above heats with preference only the surface layer of the sample material 1. In order therefore to continue to concentrate the heating as far as possible only on the uppermost liquid layer, it is envisaged to provide below the uppermost liquid layer a convergence-preventing measure.

As a further structural design feature of the device, consequently at least one net or a perforated plate (orifice plate) 30 may be horizontally incorporated as this measure just below the liquid surface 14 in the sample container 3. The orifice plate 30 is produced for example from a plastic, preferably from polytetrafluoroethylene (PTFE). In addition or alternatively, the material of the orifice plate 30 may be microwave-absorbing, and consequently be used as a passive secondary heating source. For this purpose, PTFE material may for example be filled with graphite. As an alternative to the graphite material, silicon carbide material (SiC) or other known materials may also be used. Such plates 30 then make it possible for the uppermost layers of the liquid 1 to be indirectly heated with microwave radiation. By this measure, the heating of the liquid 1 is concentrated even more intensely on the uppermost layers in the sample container 3, so that an entrainment of bubbles of higher-boiling impurities in the liquid 1 is restricted even more, and a greater purity of the liquid chemical 1 can be achieved. The great advantage of this principle is that only a small part of the liquid 1 to be distilled is actually heated. The remaining part is cold, and consequently has on the one hand a lower risk potential. On the other hand, the efficiency is much better, since a much smaller volume of liquid has to be heated.

The efficiency can also be increased still further, in that preferably further nets or perforated (orifice) plates 31 are incorporated horizontally in the liquid container 3 below the microwave-absorbing perforated plate 30. In FIG. 1, only one additional plate 31 is shown, but it is also possible for a number of plates 31 to be provided, preferably arranged horizontally offset in relation to one another. These plates 31 should preferably be microwave-permeable, in particular whenever they are arranged in deeper layers in the liquid 1, in order to avoid indirect heating of these deeper layers. Furthermore, the orifice plates 30, 31 are preferably arranged offset from one another. This structural design measure allows a reduction of the convection, i.e. the heat transfer within the liquid 1. With convection—if it takes place from the bottom upward—impurities could in turn be entrained, and restrict the purity of the liquid chemical 1 that can be achieved by the process.

A particularly high degree of purity can be achieved by these measures, since only the uppermost liquid layer is intensely heated, and consequently higher-boiling impurities are scarcely entrained by the formation of bubbles in the vapor. The purity is also improved by reducing the convection within the liquid 1. The thermal stratification in the liquid 1 to be distilled is set by these measures in such a way that, for example in the case of hydrofluoric acid, there is a temperature of about 120° C. at the surface, while approximately room temperature or ambient temperature is established at a depth of for example 10 to 30 cm (depending on the size of the sample chamber).

The action of the microwaves on the uppermost layer of the liquid chemical 1 to be purified has the effect that this uppermost layer is made to evaporate. The sample vapor 18 produced is then removed from the sample chamber 4 (see arrow P1) via the outlet stub 16 above the liquid surface 14. For this purpose, the outlet stub 16 extends out from the sample chamber 4 and passes by way of a distillation line 19 (for the path of the sample vapour 18, see arrow P2) to a condensation device 70 arranged outside the sample chamber 4 (for the path of the sample vapor 18, see arrow P3). In order to increase the path of the sample vapour 18 through the condensation device 70, the distillation line 19 in the condensation device 70 preferably extends into a spiral section of line 71. The condensation device 70 may have a water cooler or a circulating cryostat 72. Alternatively, cooling may also be performed with air. For this purpose, the coolant K is introduced into the condensation device 70 in a known way via an inlet 73, cools and condenses therein the sample vapor 18, and is removed again via an outlet 74. The condensation device 70 may in this case have an open or preferably closed cooling cycle.

At the outlet of the condensation device 70, the preferably spiral section of line 71 extends into an outlet line 75, by way of which the condensed and high-purity distillate 76 is directed into a collecting container 77.

With an appropriately controlled output of the irradiation on the surface 14 of the liquid 1, the uppermost layers are consequently heated to such a degree that the lowest-boiling component evaporates out of the liquid 1. The upwardly escaping vapor 18 passes via the outlet stub 16 and the distillation line 19 into the condensation device 70, in which the vapor 18 condenses. The condensate 76 then flows along the outlet line 75 into the collecting container 77.

Since the condensation device 70 does not have an efficiency of 100%, distillate vapor 18 continues to be present on the upper side of the collecting container 77. It is thus envisaged to provide a return line 80 for the non-condensed distillate or the non-condensed vapor 18 between the collecting container 77 and the storage vessel 41. The non-condensed distillate and the sample vapor or distillate vapor 18 can consequently be returned from the collecting container 77 (see arrow P4) into the return line 80 and via the return line 80 (see arrow P5) to the or into the storage vessel 41 (see arrow P6), from which the pump 42 pumps it into the overflow 44. Consequently, no distillate vapor 18 is lost. For this purpose, the return line 80 is provided at the collecting container 77 in a way that is closed or sealed off from the surroundings. The space between the space above the liquid surface 14 of the liquid 1 to be purified in the sample chamber 4, to be more precise in the sample container 3, and the storage vessel 41 consequently forms a space that is closed off from the surroundings, to be more precise a clean room.

As shown in FIG. 1, a device 90 for generating a negative pressure is provided in or in connection with the storage vessel 41 (solid line 93) or alternatively in or in connection with the return line 80 (dashed line 94). The device generating the negative pressure may for example be a fan 91, which by pumping off gas in the storage vessel 41 (or in the return line 80) preferably generates a vacuum therein. Therefore, a negative pressure (preferably a vacuum) is generated in a specific manner by the device 90 downstream of the condenser 70 between the collecting container 77 and the storage vessel 41, preferably in or in the region of the storage vessel 41, so that the clean-room atmosphere existing in the interior of the system is fluidically supported. The inlet side of the fan 91 generating the negative pressure is preferably provided with a filter 92, so that the system gas is closed in terms of gas flow. This also reliably prevents impurities of the distillate.

The system as represented consequently constitutes in itself a closed clean room. Since the storage vessel 41, the return line 80, the collecting container 77, the distillation line 19 and the outlet stub 16 form this space that is closed off from the surroundings, the negative pressure that is generated in the region of the storage vessel 41 also prevails on the upper side 14 of the liquid 1 to be distilled. In this way, the evaporation can be promoted. Furthermore, the vapor stream coming from the outlet stub 16 and passing through the condensation device 70 and onto the collecting container 77, that is to say the closed vapor cycle, can be promoted or enhanced by the negative pressure, so that a reliable removal of the evaporated sample material (sample vapor 18) is ensured.

Apart from measuring the temperature of the sample material 1 to be distilled, furthermore the pressure in the outlet stub 16 or the distillation line 19 is preferably also measured by way of a pressure sensor 63. The pressure sensor 63 is preferably likewise connected to the control unit 60. In the vapor channel (outlet stub 16; distillation line 19) to the condensation device 70 there should, as far as possible, never be a positive pressure. If, however, the existing pressure exceeds a limit value (limit pressure) and this is detected, a countermeasure, such as for example reducing or switching off the microwave output, is immediately introduced by way of the control unit 60.

Alternatively or in addition, the cover 17 of the lower sample chamber 6 or of the sample container 3, which upwardly closes off the vapor pressure, may also be formed so as to prevent an excessive vapor pressure. If a vapor pressure that cannot be sufficiently discharged via the upper pipe stub, that is to say the outlet stub 16, occurs in the lower sample chamber 6, or the sample container 3 (that is to say for example a predetermined vapor pressure is exceeded), the cover 17 preferably lifts off and makes it possible for the excess vapor pressure to be blown off. In order to collect this and any other vapors escaping, the system is provided at appropriate points with suction-removal devices, which make it possible for these vapors to be reliably removed.

In the case in which the condensation device 70 is formed as an air cooling device, the air stream provided for the cooling may for example be made available by the fan 91 that is used for generating the negative pressure in the system. This produces a system that is altogether closed off; including the cooling.

All of the elements that come into contact with the chemical in the course of the distillation process, such as for example the sample container 3, the condensation device 70 or the leveling system 40, must be resistant to the chemical used. Glass may be used as a material in the case of chemicals that are not excessively aggressive; if, for example, the chemical to be purified is hydrofluoric acid, which attacks glass, polytetrafluoroethylene (PTFE) may be used for example.

The process described above is suitable for producing high-purity liquids of any type, in particular for liquid chemicals such as those required in the production of semiconductors. An example of such a chemical is hydrofluoric acid. The configuration is at the same time suitable both for microwave-absorbing liquids (such as for example hydrofluoric acid, nitric acid, organic solvents, etc.), but also for liquids that do not absorb microwaves, since these can be heated passively by the microwave-absorbing inserts (orifice plates 30; for example filled with graphite material).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A process for producing high-purity liquids, in particular liquid chemicals, by distillation, the process comprising:
providing a liquid that is to be purified from a storage vessel in a sample container arranged in a sample chamber;
heating and evaporating at least an uppermost layer of the liquid to be purified;
condensing a sample vapor produced from the liquid to be purified in a condensation device outside of the sample chamber; and
collecting the distillate in a collecting container, the collecting container being connectable to the storage vessel via a return line for non-condensed sample vapor and for forming a space that is closed off from the surroundings between a space above a liquid surface of the liquid to be purified in the sample chamber and the storage vessel.

2. The process as claimed in claim 1, wherein the liquid to be purified is heated by microwave irradiation with preference in the uppermost layers.

3. The process as claimed in claim 1, wherein the liquid is heated indirectly by microwave irradiation.

4. The process as claimed in claim 1, wherein the level of the liquid surface is kept substantially constant during the process via a leveling system.

5. The process as claimed in claim 1, wherein a temperature distribution in the liquid is monitored by at least two temperature measuring devices, of which at least one temperature measuring device measures the temperature in the uppermost layer of the liquid and at least one temperature measuring device measures the temperature in a lower region of the liquid to control an output of radiation that is incident on the liquid surface and a feed of cold liquid to be purified into the sample container.

6. The process as claimed in claim 1, wherein a negative pressure or vacuum is generated in the storage vessel or in the return line by a device, the generated negative pressure also prevailing on the liquid surface of the liquid to be purified in the sample chamber via the connection to the return line.

7. The process as claimed in claim 1, wherein a pressure in an outlet stub or distillation line connecting the sample chamber and the condensation device is measured via a pressure sensor, and wherein the microwave output is reduced or switched off if a limit pressure is exceeded.

8. The process as claimed in claim 1, wherein a cover divides the sample chamber into an upper sample chamber, into which the microwaves are coupled, and a lower sample chamber, in which the sample container is received, the cover being transparent to microwaves.

9. The process as claimed in claim 8, wherein the cover lifts off from the sample container if a predetermined vapor pressure in the sample container is exceeded.

10. A device for carrying out the process as claimed in claim 1, the device comprising:
a sample chamber;
a sample container with a liquid to be purified, the sample container being arranged in the sample chamber;
a storage vessel for providing the liquid in the sample container;
a heat source configured to act on the sample container;
a condensation device connectable to the sample container and arranged outside of the sample chamber; and
a collecting container for collecting a condensed distillate, the collecting container being connectable to the storage vessel via a return line for a non-condensed sample vapor and for forming a space that is closed off from the surroundings between a space above a liquid surface of the liquid to be purified in the sample chamber and the storage vessel.

11. The device as claimed in claim 10, wherein the heat source is a microwave radiation source and is arranged above the liquid to be purified such that the uppermost layers of the liquid are heated.

12. The device as claimed in claim 10, wherein a cover divides the sample chamber into an upper sample chamber into which the microwaves are coupled and into a lower sample chamber in which the sample container is received, and wherein the cover is transparent to microwaves.

13. The device as claimed in claim 10, wherein a device for generating a negative pressure in the system is provided in or in connection with the storage vessel or in or in connection with the return line, and wherein the generated negative pressure also prevails on the liquid surface of the liquid to be purified in the sample chamber via the connection to the return line.

14. The device as claimed in claim 13, wherein the device generating the negative pressure comprises a fan, which by pumping out gas in the storage vessel or in the return line generates a vacuum therein.

15. The device as claimed in claim 13, wherein an inlet side of the device generating the negative pressure is provided with a filter.

16. The device as claimed in claim 10, wherein a pressure sensor is provided for monitoring the pressure in an outlet stub or distillation line connecting the sample chamber and the condensation device, wherein a control unit is provided for controlling an output of radiation that is incident on the liquid surface, and wherein the pressure sensor is connectable to the control unit.

17. The device as claimed in claim 10, wherein the liquid container is connectable to a leveling system for keeping a level of the liquid surface in the sample container substantially constant.

18. The device as claimed in claim 10, wherein the leveling system includes the storage vessel for the liquid to be purified, a pump, and an overflow stub into which the liquid is pumped out of the storage vessel via the pump, the overflow stub being connectable in an upper part to the storage vessel and a lower end of the overflow stub opening via an inflow into a lower region of the sample container.

19. The device as claimed in claim 18, wherein the inflow is formed as a siphon.

20. The device is claimed in claim 19, wherein an outflow device or a draining valve is provided at a lower knee of the siphon for selectively draining off impurities in the liquid to be purified.

21. The device as claimed in claim 10, wherein the condensation device is a water cooler, a circulating cryostat or an air cooler.

22. The device as claimed in claim 10, wherein the fan that is used for generating the negative pressure in the system provides the air stream for the air cooler that is intended for cooling.

23. The device as claimed in claim 10, further comprising:
at least two temperature measuring devices or infrared thermal sensors for monitoring a temperature distribution in the liquid, at least one temperature measuring device being configured to measure a temperature in an uppermost layer of the liquid and at least one temperature measuring device measures a temperature in a lower region of the liquid; and
a control device configured to control an output of the radiation that is incident on the liquid surface and/or the feed of cold liquid to be purified into the liquid container,
wherein the temperature measuring devices are connectable to the control unit.
